(19) United States
(12) Patent Application Publication
(10) Pub. No.: US 2012/0191724 A1
(43) Pub. Date: Jul. 26, 2012

(54) STORAGE OF DATA OBJECTS BASED ON A TIME OF CREATION

(76) Inventors: Joseph A. Tucek, Palo Alto, CA (US); Eric A. Anderson, Palo Alto, CA (US)

(21) Appl. No.: 13/014,694

(22) Filed: Jan. 26, 2011

(51) Int. Cl. G06F 17/30

(52) U.S. Cl. 707/747; 707/E17.052

(57) ABSTRACT

Techniques for storage of data objects based on a time of creation are disclosed. A computing device may receive a request to store a data object and, in response, identify a particular storage location that maintains data for the interval of time including a time of creation of the data object.

### BACKGROUND

A typical storage system may include a number of storage devices distributed over a number of storage nodes. Similarly, a file system may utilize physical sectors of a storage device to create a hierarchy including a number of files and directories. In determining where to store a particular data object, storage and file systems may use a variety of factors, each of which affects the performance and maintainability of the system.

### BRIEF DESCRIPTION OF THE DRAWINGS

The following detailed description references the drawings, wherein:

FIG. 1 is a block diagram of an example computing device for storing a data object a location identified based on a time of creation of the object;

FIG. 2 is a block diagram of an example computing device for storing a data object in a location in a selected device in a node, where the location is determined based on a time of creation of the object;

FIG. 3 is a flowchart of an example method for storing a data object in a location identified based on a time of creation of the object;

FIG. 4 is a flowchart of an example method for storing a data object in a location in a selected device in a selected node based on application of a hash function to a time of creation of the object;

FIG. 5A is a diagram of an example data allocation over time using a first hash method to select a storage location for data objects; and

FIG. 5B is a diagram of an example data allocation over time using a second hash method to select a storage location for data objects.

### DETAILED DESCRIPTION

As detailed above, a typical storage or the system may use a variety of factors in placing data in the system. Regardless of the particular factors used to place data, a storage system generally strives to reach a balance between the competing interests of locality and spreading of data. Locality of data refers to the placement of related data in a physically-proximate area of storage. By proximately arranging objects that are likely to be accessed at the same time, the system may minimize the time required for Input/Output (I/O) operations. In contrast, spreading of data refers to the distribution of data throughout the system, such that the components of the system are used evenly over time and thereby experience a longer viable life.

Existing solutions often fail to strike the proper balance between locality and spreading of data. For example, some systems determine the storage location for an object on a first-available basis, such that the system sequentially fills available storage disks or blocks. While these systems exhibit strong locality, they lack proper spreading of data, which may increase the likelihood of performance hot spots and fragmented allocation. In contrast, other systems determine the storage location for an object in an essentially random fashion. These systems therefore provide for highly distributed data, but provide little to no locality.

Other solutions fail to provide a viable solution in situations in which a usable locality cue is not present. For example, one system determines a location for the data among a number of different directories assigned to different areas of a disk based on a hierarchy of the data namespace. Although this system provides a satisfactory solution where locality can be inferred from the namespace hierarchy, in many data collections, the namespace does not provide a strong inference regarding locality. Accordingly, this method of data allocation exhibits poor locality in systems with a flat, non-hierarchical namespace, systems with a large number of directories each containing few items, and systems in which the namespace has no relation to object access patterns, to name a few examples.

To address these issues, example embodiments disclosed herein store data in a manner that provides both locality and data distribution using a readily-available locality cue. In particular, example embodiments group data objects into storage locations based on the time of creation of the data objects. For example, a computing device may receive a request to store a data object and, in response, identify a particular storage location that maintains data for the interval of time including a time of creation of the data object. In response, the computing device may trigger storage of the data object in the identified location. In some embodiments, the determination of the location may be based on a calculation applied to the time of creation, such as a hash function,

In this manner, example embodiments disclosed herein provide for a balance between data locality and data spreading based on a readily-available locality cue, the time of creation of each data object. Example embodiments thereby provide for strong locality and spreading, even in systems with a flat namespace or systems in which the namespace has no relation to object access patterns. Accordingly, example embodiments provide for increased performance, while also preventing performance hot spots and providing for even wear on storage components. Additional embodiments and applications of such embodiments will be apparent to those of skill in the art upon reading and understanding the following description.

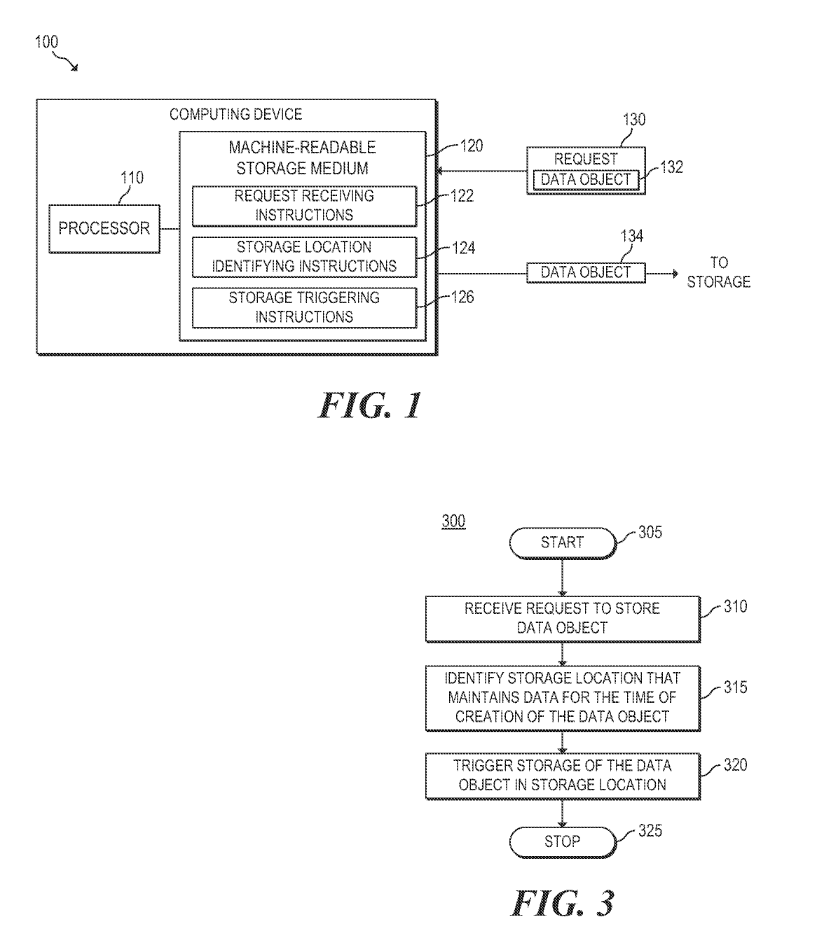

Referring now to the drawings, FIG. 1 is a block diagram of an example computing device 100 for storing a data object in a location identified based on a time of creation of the object. Computing device 100 may be, for example, a storage server, a notebook computer, a desktop computer, a slate computing device, a wireless email device, a mobile phone, or any other computing device. In the embodiment of FIG. 1, computing device 100 includes processor 110 and machine-readable storage medium 120.

Processor 110 may be one or more central processing units (CPUs), semiconductor-based microprocessors, storage controllers, and/or other hardware devices suitable for retrieval and execution of instructions stored in machine-readable storage medium 120. Processor 110 may fetch, decode, and execute instructions 122, 124, 126 to implement the data object placement procedure described in detail below. As an alternative or in addition to retrieving and executing instructions, processor 110 may include one or more integrated circuits (ICs) or other electronic circuits that include a number of electronic components for performing the functionality of one or more of instructions 122, 124, 126.

Machine-readable storage medium 120 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read-Only Memory (CD-ROM), and the like.

As described in detail below, machine-readable storage medium 120 may be encoded with a series of executable instructions 122, 124, 126 for determining a storage location for a data object using the time of creation of the data object. For example, computing device 100 may execute instructions 122, 124, 126 as a portion of an application. In other embodiments, instructions 122, 124, 126 may be implemented by the operating system of computing device 100 to create and maintain a file system. Alternatively, instructions 122, 124, 126 may be implemented by a storage controller included in computing device 100 to manage storage instructions provided to a storage device or to a group of storage devices.

Regardless of the particular implementation, machine-readable storage medium 120 may include request receiving instructions 122, which may receive a request 130 to store a data object 132. The request 130 may originate in, for example, a process executing in computing device 100, such as an application that has issued a command to the operating system of device 100 to store a particular piece of data. As another example, the request may originate from a host computing device that desires to utilize storage provided by or accessible to computing device 100.

The received data object 132 may be a file, a piece of a file, or any other chunk or piece of data to be stored by computing device 100. Data object 132 may include associated data that may be used by identifying instructions 124 in determining an appropriate storage location. For example, data object 132 may include or be associated with a collection of metadata. This metadata may include a timestamp or other data type indicating a time at which the data object 132 was created. As an alternative to receiving the time of creation in the metadata of object 132, request 130 may include a separate parameter specifying the time of creation of data object 132. It should be noted that, as used herein, the time of creation may also refer to the time the data object was last modified.

The time of creation associated with the data object 132 may be formatted in a variety of ways. For example, in some embodiments, the timestamp may include a plurality of bits (e.g., 16 bits, 32 bits, etc.) representing a specific time and date. The time may be formatted according to a known standard for specifying dates and times, such as ISO 8601, published by the International Organization for Standardization. Alternatively, the time may be expressed in Unix time, which is a value representing the number of seconds elapsed since 00:00:00 UTC on Jan. 1, 1970. It should be noted that the time of creation need not represent an actual point in time: rather, in some embodiments, the time of creation may represent an elapsed amount of time from an arbitrary point in time or an amount of time remaining until reaching that arbitrary point in time. Other suitable formats for specifying the time of creation of data object 132 will be apparent to those of skill in the art.

Upon receipt of a storage request 130 and a corresponding data object 132, receiving instructions 122 may trigger storage location identifying instructions 124, which may identify a storage location for data object 132 using the associated time of creation. The identified storage location may be a particular physical location (e.g., a particular segment of sectors in a storage device) or a non-physical location (e.g., a directory or folder created as an abstraction of a portion of physical storage space).

As mentioned above, location identifying instructions 124 may divide the storage space into a number of sub-areas, each corresponding to an interval of time. More specifically, by applying a calculation to the time of creation, location identifying instructions 124 may divide the storage space into a number of locations, where each location maintains data for a particular interval of time of a given duration. In general, identifying instructions 124 may first derive a lower precision unit of time from the time of creation of the data object and may then map the lower precision unit of time to the particular storage location.

For example, suppose the timestamp is a value of 1043 in decimal, which corresponds to “00000100 00010011” as a 16-bit binary number. In this case, identifying instructions 124 may first derive a lower precision unit of time by, for example, truncating a set of least significant bits from the time of creation of data object 132. It should be noted that, as used herein, truncating generally refers to the replacement of some number of digits of a number with “0.” Thus, here, by truncating the last 9 bits, data objects may be grouped into 512 second intervals. More specifically, “00000100 00010011” may be truncated to “00000100 00000000” in binary or 1024 in decimal, such that any data object with a 16-bit timestamp beginning with “0000010” will map to the same lower precision unit of time. It should be noted that different truncation points may be applied depending on the implementation. For example, 8 binary digits may be truncated for 256 second intervals, 10 digits may be truncated for 1,024 second intervals, etc.

It should also be noted that other mathematical functions in addition to a simple truncation may be used to derive the lower precision unit of time, such as a division operation combined with a floor or ceiling function. Furthermore, the truncation operation may be applied to any numeric representation of the time. For example, the truncation operation may be applied to the time of creation represented in binary, decimal, hexadecimal, or any other numbering system.

After deriving the lower precision unit of time, identifying instructions 124 may map the lower precision unit of time to a particular storage location. For example, identifying instructions 124 may apply a hash function to the lower precision unit of time to obtain a hash value that corresponds to the particular storage location. The hash function may be any function that maps an input set of values of a first size to a smaller output set of values in a deterministic manner. In other words, the output of the hash function is fixed for a given input value. Furthermore, in some embodiments, the input and output of the hash function are unrelated (i.e., the only way to determine the output is to compute the hash on the input) and all bits of the output are dependent on the input. For example, the hash function may be the Secure Hash Algorithm 1 cryptographic hash function, also known as SHA-1 After determining the hash value by applying the hash function to the lower precision unit of time, identifying instructions 124 may identify the location using the hash value itself (e.g., a directory with the name equal to the hash value) or by mapping the hash value to the storage location (e.g., using a look-up table or similar data structure).

Continuing with the previous example, the lower precision unit of time is 1024 in decimal or “00000100 00000000” in binary. Suppose the hash function is h(k)=(k*314159) % 10, such that the lower precision unit of time maps to one of 10 possible storage locations. Here, applying the hash function to 1024, the resulting value is 6. Accordingly, the corresponding data object may be stored in directory “6” or in a location corresponding to the value “6,” as determined using a look-up table or other data structure. To generalize, the above-identified hash function may be varied depending on the number of desired storage locations. Thus, a suitable hash function may be, for example, h(k)=(k*R) % N, where N is an integer number of desired storage locations and R is any integer such that (k*R) % N provides a substantially even distribution of numbers between 0 and N-1. As another example, the hash function may be a cryptographic hash or a Bob Jenkins hash function, such as the one-at-a-time hash, lookup2, or lookup3 hash functions.

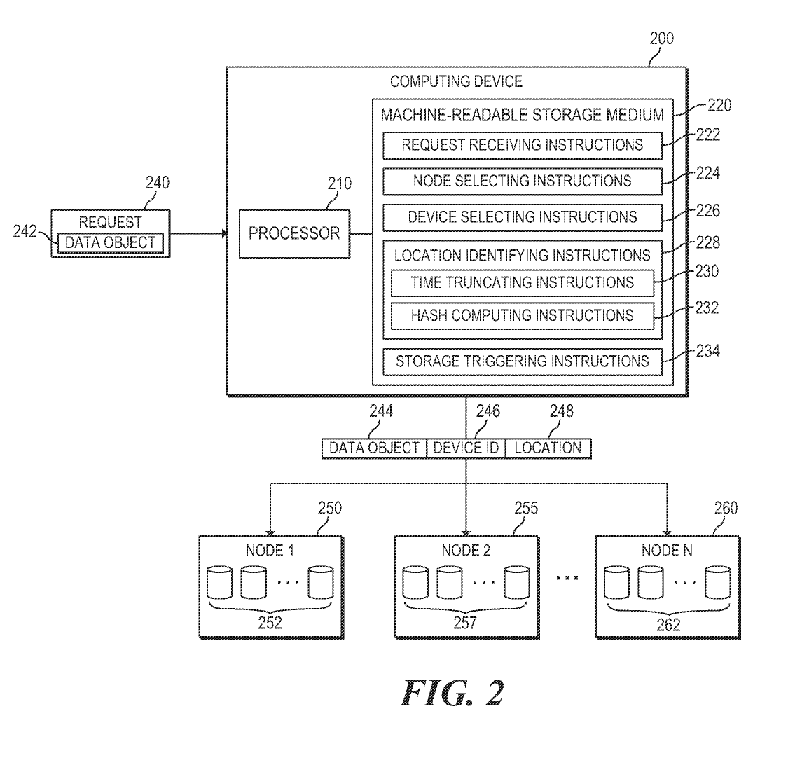

In some embodiments, the identified storage location may be located in a particular storage device in a particular storage node. In such embodiments, location identifying instructions 124 may also determine the appropriate storage node and device either randomly or based on some other criteria, such as the time of creation of data object 132. Additional details regarding such implementations are provided below in connection with node selecting instructions 224 and device selecting instructions 226 of FIG. 2.

After identifying instructions 124 determine the appropriate storage location for data object 132, storage triggering instructions 126 may trigger storage of data object 134 in the corresponding location in a storage area accessible to computing device 100. For example, when computing device 100 implements a the system, instructions 126 may issue a command to the file system or storage device including an instruction to store data object 134 in the identified location. Similarly, when computing device 100 manages receipt and execution of commands for an array or other group of storage devices, storage triggering instructions 126 may issue a command to the appropriate storage node including an instruction to store data object 134 in the identified location in the identified storage device.

FIG. 2 is a block diagram of an example computing device 200 for storing a data object 242 in a location in a selected device 252, 257, 262 in a node 250, 255, 260, where the location is determined based on a time of creation of the object. As with computing device 100 of FIG. 1, computing device 200 may be a storage server, a notebook computer, a desktop computer, a slate computing device, a wireless email device, a mobile phone, or any other computing device. Computing device 200 may include a processor 210, which may be configured similarly to processor 110 of FIG. 1. Computing device 200 may also include a machine-readable storage medium 220 encoded with executable instructions for storing a data object 242 in a determined location in a selected storage device accessible to a selected storage node.

Thus, machine-readable storage medium 220 may include request receiving instructions 222, which may receive a request 240 to store a data object 242 in one of the storage nodes 250, 255, 260. Request 240 and data object 242 may be formatted similarly to request 130 of FIG. 1 and data object 132 of FIG. 1, respectively. In some embodiments, request 240 may identify neither a particular node nor a particular device for storage of the object 242. In such embodiments, receiving instructions 222 may first trigger node selecting instructions 224 for selection of the node and then trigger device selecting instructions 226 for selection of the device. In other embodiments, the request may identify a particular node, but not a particular storage device, and receiving instructions 222 may therefore trigger device selecting instructions 226. Alternatively, the request may specify both a node and a storage device and receiving instructions 222 may therefore directly trigger location identifying instructions 228.

When request 240 does not specify a particular node, node selecting instructions 224 may be configured to select a node for storage of object 242 from a plurality of storage nodes 250, 255, 260. Instructions 224 may randomly select a particular node from the set of storage nodes 250, 255, 260. Alternatively, in other embodiments, instructions 224 may select a node based on application of a hash function to the lower precision unit of time derived by time truncating instructions 230 using the time of creation of data object 242. For example, the hash function may be configured to output N possible values based on receipt of a truncated timestamp, where N is the total number of nodes 250, 255, 260. Such embodiments are advantageous, as they naturally cluster accesses to a single node during a given period of time, thereby allowing the system to power-down storage devices in other nodes for power savings.

When request 240 does not specify a particular storage device 252, 257, 262, device selecting instructions 226 may be configured to select a particular device on the selected storage node. For example, when the selected node is node 250, instructions 226 may select from the storage devices 252 in node 250. Similarly, when the selected node is node 255 or node 260, instructions 226 may select from the storage devices 257, 262, respectively. In selecting a particular storage device, in some embodiments, instructions 226 may randomly select the particular storage device from the set of storage devices on the selected node. Alternatively, in other embodiments, as with node selecting instructions 224, instructions 226 may select a storage device based on application of a hash function to the lower precision unit of time derived by time truncating instructions 230 using the time of creation of data object 242. Such embodiments are advantageous, as they naturally cluster accesses to a single storage device during a given period of time, thereby allowing the system to power-down other storage devices for power savings.

Location identifying instructions 228 may identify, from a plurality of storage locations in the selected storage device 252, 257, 262, a particular location for storage of the data object that maintains data for an interval of time including the time of creation of the data object. The identified storage location may be a particular portion of the selected storage device, such as a directory or folder, a partition, or any other selectable portion of the device.

In determining the particular location, identifying instructions 228 may apply a calculation to the time of creation. For example, time truncating instructions 230, described in further detail below, may calculate a lower precision unit of time from the time of creation of the data object. Hash computing instructions 232 may then apply a hash function to the lower precision unit of time to obtain a hash value. Identifying instructions 228 may then determine the particular location that corresponds to the obtained hash value on the identified storage device 252, 257, 262 in the identified storage node 250, 255, 260.

More specifically, time truncating instructions 230 may apply a truncation operation to the time of creation of data object 242 to group the data object 242 with other objects in the same interval. For example, as detailed above in connection with identifying instructions 124 of FIG. 1, time truncating instructions 230 may truncate (i.e., replace a number of bits with “0”) a set of least significant bits from the time of creation, thereby resulting in a time of creation with a number of higher significance bits. To give a few specific examples, truncating 2 bits will result in intervals of 4 units of time (e.g., 4 seconds), truncating 4 bits will result in intervals of 16 units of time, etc. It should be noted that the truncation function may be adapted according to the unit of time used to specify the time of creation, such that more bits are truncated from the time of creation for a higher precision unit of time, such as milliseconds, than for a lower precision unit of time, such as seconds or minutes.

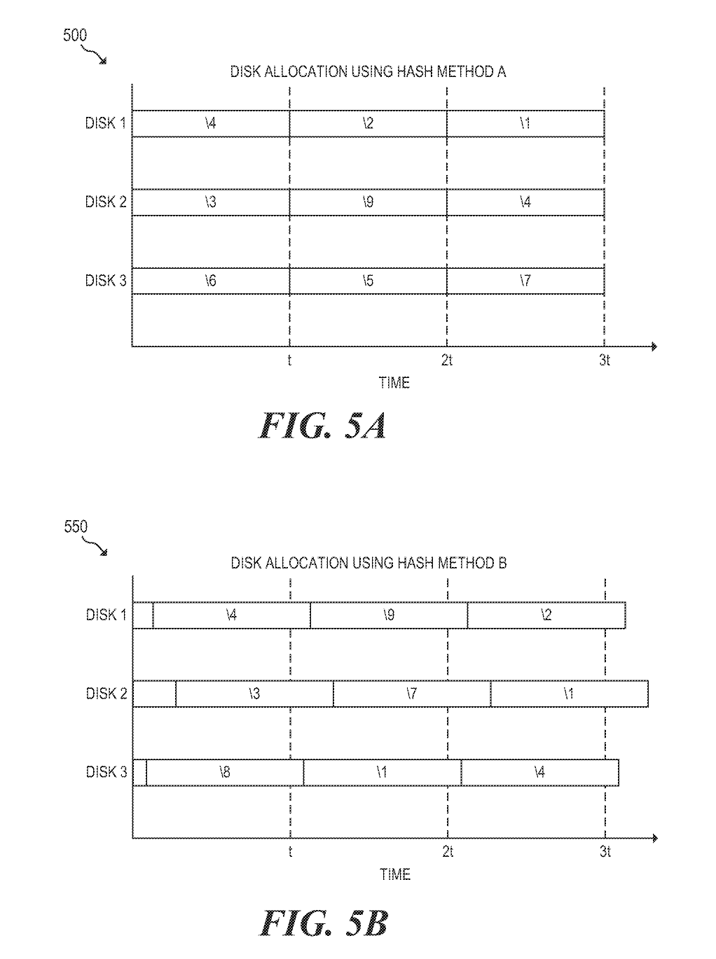

In some embodiments, truncating instructions 230 may apply the truncation function directly without prior manipulation of the time of creation. In such embodiments, as illustrated in FIG. 5A and described in further detail below, the time at which each storage device switches storage to a new location is therefore synchronized between the storage devices 252, 257, 262. In other embodiments, truncating instructions 230 may first modify the timestamp by combining it with a value determined based on an identifier of the selected storage device. For example, instructions 230 may compute a hash value from the identifier of the selected storage device, add this value to or subtract it from the time of creation, and then apply the truncation operation. As illustrated in FIG. 5B and described in further detail below, such embodiments prevent the synchronization of the rollover point for each storage device.

Truncating instructions 230 may be configured to truncate the time of creation to either a fixed level or to a variable level. For example, when truncating the time of creation to a fixed level, truncating instructions 230 may apply the same truncation operation each time. In this manner, each storage location may maintain data for intervals of time of a fixed duration (e.g., 128 seconds, 512 seconds, etc.). Alternatively, truncating instructions 230 may vary the level of truncation over time. For example, truncating instructions 230 may dynamically modify the level of truncation based on a level of expected or actual activity during the interval of time. Thus, when there is currently a high level of storage activity in nodes 250, 255, 260, truncating instructions 230 may decrease the interval of time for each storage location by decreasing the level of truncation. Conversely, when there is currently a low level of activity, truncating instructions 230 may increase the duration of the interval by increasing the level of truncation.

After determination of the lower precision unit of time, hash computing instructions 232 may apply a hash function to the lower precision unit of time to obtain a hash value corresponding to the particular storage location on the selected storage device. Several example hash functions and characteristics of such functions are described above in connection with storage location identifying instructions 124.

In some embodiments, hash computing instructions 232 may apply the hash function directly to the truncated time of creation. Alternatively, hash computing instructions 232 may apply the hash function to a combination of the truncated time of creation and some other value. As one example, instructions 232 may apply the hash function to the truncated time of creation in combination with an identifier of the selected storage node and/or an identifier of the selected storage device. For example, instructions 232 may apply the hash function to the truncated time of creation plus the node ID and/or device ID. Such embodiments are beneficial in preventing hotspots in storage due to the presence of time periods that are busier than others in terms of object creation. In particular, hashing in the node ID and/or device ID reduces the likelihood that hotspots will simultaneously occur on multiple nodes.

As another example of the application of the hash function to a modified time of creation, hash computing instructions 232 may instead hash the time of creation with a variable characteristic of the data object 242. For example, hash computing instructions 232 may select a variable field, such as the object's identifier (e.g., name, numeric identifier, etc.) and apply a hash function to the variable field. Instructions 232 may then combine (e.g., add or subtract) the hashed value with the truncated time of creation and apply the hash function to the combined value. Such embodiments are useful in providing more spreading of data, such that the data during a particular interval of time may map to one of several possible locations based on the value of the variable field.

After execution of hash computing instructions 232, location identifying instructions 226 may determine the particular storage location corresponding to the hash value. For example, identifying instructions 226 may map the hash value to a particular directory or other location corresponding to the hash value. The directory or location may be identified to be the hash value itself (e.g., a directory with the name “1” or “2”) or may be determined using a look-up table (e.g., a table that maps the value “1” to a directory with the name “A”). Furthermore, each of these operations may be performed using the entire hash value or, alternatively, a truncated version of the resulting hash value.

After location identifying instructions 228 determine the location in the selected storage device in the selected node, storage triggering instructions 234 may cause storage of data object 242 as data object 244. For example, triggering instructions 234 may transmit the data object 244, the identifier of the selected storage device 246, and the identified location 248 to the identified storage node 250, 255, 260. In addition, triggering instructions 234 may include an appropriate command that instructs a controller in the receiving node 250, 255, 260 to initiate storage of data object 244.

Nodes 250, 255, 260 may be any computing devices configured to receive storage input/output commands and, in response, execute the corresponding operation. For example, each node 250, 255, 260 may include a storage controller to receive a command to read or write a portion data and, in response, to access a particular location in a particular storage device 250, 255, 260 to execute the read or write operation.

Each node 250, 255. 260 may include one or more storage devices 252, 257, 262 for storage of data. Each storage device 252, 257, 262 may be a hard disk drive, a solid state drive, a tape drive, a nanodrive, a holographic storage device, or any other hardware device capable of storing data for subsequent access. When a given node 250, 255, 260 includes a plurality of storage devices 252, 257, 262, the storage devices may form, in combination, a pool of available storage. Thus, as an example, the devices 252, 257, 262 may collectively form a Redundant Array of Inexpensive Disks (RAID), a spanning set of disks, or some other combined configuration. Alternatively, devices 252, 257, 262 may be an independent set of disks.

FIG. 3 is a flowchart of an example method 300 for storing a data object in a location identified based on a time of creation of the object. Although execution of method 300 is described below with reference to computing device 100, other suitable components for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 may start in block 305 and proceed to block 310, where computing device 100 may receive a request to store a data object. For example, computing device 100 may receive a file, a piece of a file, or another chunk of data along with an instruction to store the object in a location to be identified by computing device 100.

Accordingly, upon receipt of the request, method 300 may continue to block 315, where computing device 100 may identify a storage location that maintains data based on the time of creation of the data object. Computing device 100 may initially derive a lower precision unit of time from a timestamp or other representation of the time of creation of the data object. For example, computing device 100 may truncate the timestamp to a predetermined length or number of bits. Computing device 100 may then map the lower precision unit of time to a corresponding storage location. For example, computing device 100 may apply a hash function to the lower precision unit of time to derive a hash value. Computing device 100 may then identify the storage location as the hash value or, alternatively, based on a look-up using the hash value.

Finally, after computing device 100 identifies the appropriate storage location, method 300 may proceed to block 320. In block 320, computing device 100 may trigger storage of the data object in the identified storage location. Method 300 may then proceed to block 325, where method 300 may stop.

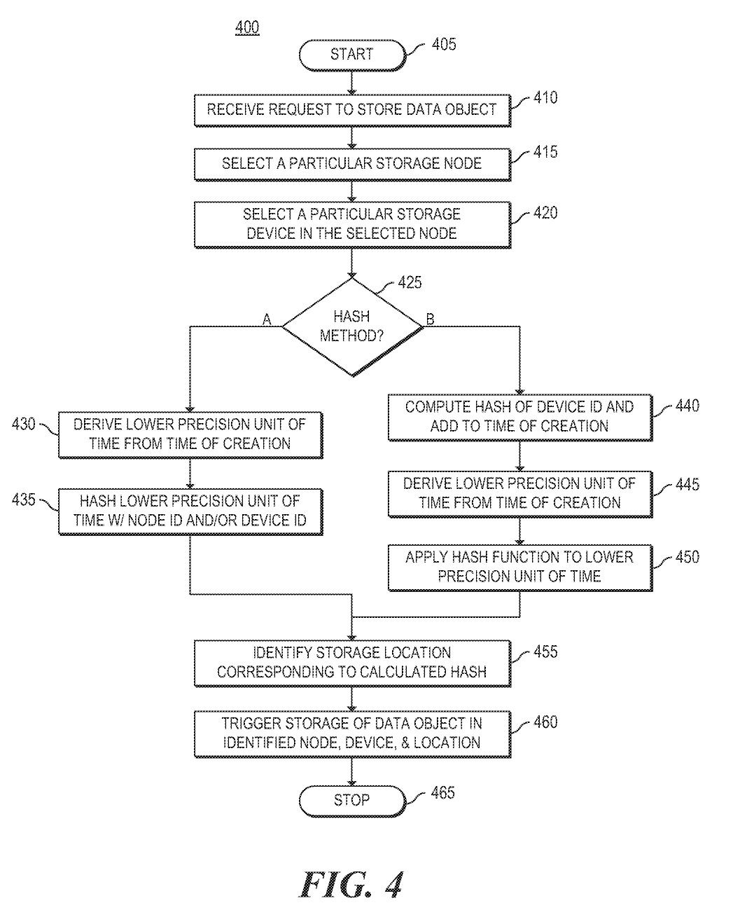

FIG. 4 is a flowchart of an example method 400 for storing a data object in a location in a selected device in a selected node based on application of a hash function to a time of creation of the object. Although execution of method 400 is described below with reference to computing device 200, other suitable components for execution of method 400 will be apparent to those of skill in the art. Method 400 may be implemented in the form of executable instructions stored on a machine-readable storage medium, such as storage medium 220, and/or in the form of electronic circuitry.

Method 400 may start in block 405 and proceed to block 410, where computing device 200 may receive a request to store a data object. Next, in block 415, computing device 200 may select a particular storage node 250, 255, 260 for storage of the data using information included with the request or, alternatively, by selecting a particular node randomly or by applying a hash function to the time of creation of the data object. Computing device 200 may similarly select a particular storage device in the selected storage node in block 420.

Next, computing device 200 may perform a series of actions between blocks 425 and block 455 to select a storage location in the selected storage device that maintains data for an interval of time corresponding to the time of creation of the data object. When a first hash method, A, is to be used, method 400 may branch from block 425 to block 430.

In block 430, computing device 200 may derive a lower precision unit of time from the time of creation of the data object to be stored. For example, computing device 200 may apply a truncation function directly to the time of creation to group the data object into an interval of time including other data objects created during the same interval. The duration of this interval of time may be tailored based on the truncation function applied. For example, truncating more digits or bits may result in longer intervals of time for which data objects are grouped.

Next, in block 435, computing device 200 may determine a hash value based on application of a hash function to the lower precision unit of time and at least one of an identifier of the selected node and an identifier of the selected storage device. Thus, computing device 200 may combine the unit of time obtained in block 435 with the node ID, the device ID, or both using a mathematical operation, such as multiplication or addition. Then, computing device 200 may apply the hash function to the combined value to obtain a hash value. Method 400 may then continue to block 455, where, as described in detail below, computing device 200 may determine a storage location corresponding to the computed hash value.

Alternatively, when a second hash method, B, is to be used, method 400 may branch from block 425 to block 440. In block 440, computing device 200 may first compute a hash value of the device identifier of the device selected in block 420. Computing device 200 may then add this hash value to the time of creation of the data object to obtain a time of creation offset by an essentially random value corresponding to the device ID.

Next, in block 445, computing device 200 may derive a lower precision unit of time from the modified time of creation. For example, as described in connection with block 430, computing device 200 may apply a truncation function to the modified time of creation to group the data object into an interval of time including other objects created during the same interval. Then, in block 450, computing device 200 may apply a hash function to the lower precision unit of time calculated in block 445 to obtain a hash value. Method 400 may then continue to block 455.

In block 455, computing device 200 may identify the storage location corresponding to the hash value computed in block 435 or block 450. In particular, computing device 200 may identify the storage location as a directory in the storage device with the same name as the hash value. Alternatively, computing device 200 may identify the storage location based on a look-up using a table or other data structure to determine a directory corresponding to the computed hash value. Next, in block 460, computing device 200 may trigger storage of the data object in the identified location in the node selected in block 415 and the storage device selected in block 420. Finally, method 400 may proceed to block 465, where method 400 may stop.

FIG. 5A is a diagram of an example data allocation 500 over time using a first hash method to select a storage location for data objects. In particular, data allocation 500 illustrates the allocation of data across three hard disks in a storage node when the unmodified time of creation is truncated to form time intervals of duration t and is subsequently hashed to a value between 0 and 9 to determine the storage directory.

Thus, as illustrated, between time 0 and t, Disk 1 stores objects in directory “4,” Disk 2 stores objects in directory “3,” and Disk 3 stores objects in directory “6.” At times t and 2t, each truncated time of creation ticks over to a next value. Accordingly, between time t and 2t. Disk 1 stores data in directory “2,” Disk 2 stores data in directory “9,” and Disk 3 stores data in directory “3.” Finally, between time 2t and 3t, Disk 1 stores data in directory “1,” Disk 2 stores data in directory “4,” and Disk 3 stores data in directory “7.” This process continues while the storage system is operational, such that each disk identifies a next directory for storage of data at multiples of t.

FIG. 5B is a diagram of an example data allocation 550 over time using a second hash method to select a storage location for data objects. In particular, data allocation 550 illustrates the allocation of data across three hard disks in a storage node when the time of creation is modified based on addition of a hash value of a disk identifier, truncated to form time intervals of duration t, and then hashed to a value between 0 and 9 to determine the storage directory.

In contrast to FIG. 5A, the time at which each hard disk switches to a new storage directory is not synchronized. In particular, because the system adds a hash value of the disk identifier to the time of creation prior to truncation, the disk identifier introduces variance into the truncation operation. Thus, as illustrated, Disk 1 switches to a new directory at approximately t/7, 8t17, and 15t/7. Similarly, Disk 2 switches to a new directory at approximately t14, 5t/4, and 9t14. Finally, Disk 3 switches directories at roughly t/10, 11t/10, and 21t/10.

It should be noted that, in addition to variance in the rollover points in each disk, some embodiments may also introduce variance in the duration of the interval of time. For example, the system may dynamically vary the truncation operation, such that the interval of time decreases during periods of high activity and increases during periods of low activity. Additional details regarding such embodiments are provided above in connection with time truncating instructions 230.

According to the foregoing, example embodiments disclosed herein provide for placement of data in a manner that provides for balance between data locality and data spreading based on a readily-available locality cue, the time of creation of each data object. Accordingly, example embodiments provide for increased performance, while also preventing performance hot spots and providing for even wear on storage components.

1. A computing device for determining a storage location for a data object based on a time of creation of the data object, the computing device comprising:
a processor to:
receive a request to store the data object,
identify, from a plurality of storage locations, a particular location for storage of the data object that maintains data for an interval of time including the time of creation of the data object based on a calculation applied to the time of creation, and
trigger storage of the data object in the particular location.

2. The computing device of claim 1, wherein each storage location maintains data for at least one interval of time corresponding to a range of times of creation, wherein each interval of time is of a fixed duration.

3. The computing device of claim 1, wherein each storage location maintains data for at least one interval of time corresponding to a range of times of creation, wherein a duration of each interval of time varies based on a level of expected activity during the interval of time.

4. The computing device of claim 1, wherein, to identify the particular location, the processor is configured to:
calculate a lower precision unit of time from the time of creation of the data object, and
map the lower precision unit of time to the particular location.

5. The computing device of claim 4, wherein:
to calculate the lower precision unit of time, the processor is configured to truncate a set of least significant bits from the time of creation of the data object, and
to map the lower precision unit of time to the particular location, the processor is configured to apply a hash function to the truncated time of creation to obtain a hash value corresponding to the particular location.

6. The computing device of claim 1, wherein, to identify the particular location, the processor is configured to:
select a storage node,
select a particular storage device in the selected storage node, and
identify the particular location as a particular portion of the selected storage device that maintains data for the interval of time including the time of creation of the data object.

7. The computing device of claim 6, wherein, to identify the particular location, the processor is configured to:
truncate a set of least significant bits from the time of creation of the data object, and
apply a hash function to a combination of the truncated time of creation and at least one of an identifier of the selected node and an identifier of the selected storage device.

8. The computing device of claim 7, wherein the processor is configured to apply the hash function to the truncated time of creation and a hash value computed based on a variable portion of an identifier of the data object.

9. The computing device of claim 7, wherein the processor is configured to randomly select the storage node and the particular storage device.

10. The computing device of claim 7, wherein the processor is configured to select at least one of the storage node and the storage device based on application of a second hash function to the truncated time of creation.

11. The computing device of claim 6, wherein:
the processor is configured to identify the particular location based on application of a hash function to a lower precision unit of time, and
the lower precision unit of time is derived from the time of creation of the data object and a value determined based on an identifier of the selected storage device.

12. A non-transitory computer-readable storage medium encoded with instructions executable by a processor of a computing device for determining a storage location for a data object based on a time of creation of the data object, the machine-readable storage medium comprising:
instructions for receiving a request to store the data object;
instructions for identifying a storage location for the data object by applying a hash function to the time of creation of the data object, the identified location maintaining data for an interval of time corresponding to the time of creation; and
instructions for triggering storage of the data object in the identified storage location.

13. The non-transitory computer-readable storage medium of claim 12, wherein the instructions for identifying comprise:
instructions for deriving a lower precision unit of time from the time of creation of the data object;
instructions for applying the hash function to the lower precision unit of time to obtain a hash value; and
instructions for identifying the storage location corresponding to the hash value.

14. The non-transitory computer-readable storage medium of claim 13, wherein:
the instructions for deriving are configured to derive the lower precision unit of time by truncating a set of least significant bits from the time of creation.

15. The non-transitory computer-readable storage medium of claim 12, wherein the instructions for identifying the storage location comprise:
instructions for selecting a storage node;
instructions for selecting a particular storage device in the selected storage node; and
instructions for identifying the storage location as a particular portion of the selected storage device that maintains data for the interval of time corresponding to the time of creation of the data object.

16. The non-transitory computer-readable storage medium 15, wherein the instructions for identifying identify the storage location by applying the hash function to:
a lower precision unit of time derived from the time of creation of the data object, and
at least one of an identifier of the selected storage node and an identifier of the selected storage device.

17. A computer-implemented method for determining a storage location for a data object based on a time of creation of the data object, the method comprising:
receiving, by a processor of a computing device, a request to store the data object;
selecting a storage node;
selecting a storage device in the selected storage node; and
selecting a storage location in the selected storage device, the selected storage location maintaining data for an interval of time corresponding to the time of creation of the data object.

18. The method of claim 17, wherein selecting the storage location comprises:
deriving a lower precision unit of time from the time of creation of the data object;
applying a hash function to the lower precision unit of time to obtain a hash value; and
identifying the storage location corresponding to the hash value.

19. The method of claim 18, wherein applying the hash function comprises:
applying the hash function to the lower precision unit of time and at least one of an identifier of the selected node and an identifier of the selected storage device.

20. The method of claim 18, wherein applying the hash function comprises:
applying the hash function to the lower precision unit of time and a hash value obtained based on a variable portion of an identifier of the data object.
